(19) United States
(12) Patent Application Publication
(10) Pub. No.: US 2026/0134792 A1
(43) Pub. Date: May 14, 2026

(54) SYSTEM AND METHOD FOR REAL-TIME GENERATION OF TRAINING TACTICS

(71) Applicant: Rockwell Collins, Inc., Cedar Rapids, IA (US)

(72) Inventors: Meghan ANDERSON, Elkhorn, NE (US); Sean HOWARD, Cedar Rapids, IA (US)

(73) Assignee: Rockwell Collins, Inc., Cedar Rapids, IA (US)

(21) Appl. No.: 18/941,562

(22) Filed: Nov. 8, 2024

(51) Int. Cl. G09B 9/00; F41A 33/00; G09B 9/08

(52) U.S. Cl. CPC G09B 9/003; F41A 33/00; G09B 9/08

(57) ABSTRACT

A live, virtual, and constructive (LVC) training system includes a weapons bus of a shooter aircraft that receives input data from component of the shooter aircraft. A tactical input/output (I/O) interface of a tactical training system of the LVC system receives the input data. The tactical I/O interface batches the input data in response to an event. A training tactics database generates at least one tactical scenario from scenarios stored within the database based on the batched input data and data related to a user identification stored within the database. An exercise controller executes simulations to generate at least one input vector based on the at least one scenario. A select tactics model receives the at least one input vector and determines a selected tactic to provide within the LVC system.

### FIELD OF THE INVENTION

The subject matter disclosed herein relates to the generation of training tactics. In particular, the subject matter disclosed herein relates to the real-time generation of training tactics using various types of data.

### BACKGROUND OF THE INVENTION

Several factors may contribute to missed shots during tactical situations, including weather, visual loss or impairment, quick change in speed or distance between the adversary, and the like. Missed shots may refer to discharging a weapon, particularly one mounted on an aircraft. Trainers often learn through trial and error when the most appropriate time is to shoot given timing, weapon, and type of adversary. The training provided to most pilots, however, may not be enough to make them aware of all possible options in their tactics and the timing of implementing those options.

It may be appreciated that a need exists for a system to provide improved methods for real-time generation of training tactics to improve pilot training.

### SUMMARY OF THE INVENTION

The present disclosure is directed, in a first aspect, to a system for generating live, virtual, and constructive training tactics. The system includes a tactical input/output (I/O) interface configured to receive input data and batch the input data in response to an event. The system also includes a training tactics database configured to generate at least one tactical scenario from scenarios stored within the training tactics database. The at least one tactical scenario is generated based on the batched input data and data related to a user identification stored within the training tactics database. The system also includes an exercise controller configured to execute simulations for each tactical scenario of the at least one tactical scenario to generate at least one input vector. The system also includes a select tactics model configured to receive the at least one input vector to determine a selected tactic in response to the event.

In yet another embodiment, the present disclosure is directed to a live, virtual, and constructive (LVC) training system for an aircraft. The LVC training system includes a weapons bus to receive input data from components related to the aircraft. The LVC training system also includes a user interface to provide a selected tactic to a user of the aircraft. The LVC training system also includes a tactical training system to generate the selected tactic used by the user interface. The tactical training system includes a tactical input/output (I/O) interface configured to receive the input data and batch the input data in response to an event related to the aircraft. The tactical training system also includes a training tactics database configured to generate at least one tactical scenario from scenarios stored within the training tactics database. The at least one tactical scenario is generated based on the batched input data and data related to a user identification of the user stored within the training tactics database. The tactical training system also includes an exercise controller configured to execute simulations for each tactical scenario of the at least one tactical scenario to generate at least one input vector. The tactical training system also includes a select tactics model configured to receive the at least one input vector to determine the selected tactic in response to the event.

In yet another embodiment, the present disclosure is directed to a method for generating real-time tactics for a live, virtual, and constructive (LVC) training system. The method includes receiving input data at a tactical input/output (I/O) interface of a tactical training system of the LVC system. The method also includes batching the input data in response to an event within the LVC system. The method also includes generating at least one tactical scenario from scenarios stored at a training tactics database based on the batched data and data related to a user identification stored within the training tactics database. The method also includes executing simulations at an exercise controller from each tactical scenario of the at least one tactical scenario. The method also includes generating at least one input vector for the at least one tactical scenario by the exercise controller based on the simulations. The method also includes determining a tactic for the LVC system based on the at least one input vector using a select tactics model.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a live, virtual, and constructive (LVC) system for training a pilot according to the disclosed embodiments.

FIG. 2 illustrates a block diagram of an LVC tactical training system for use with the LVC system according to the disclosed embodiments.

FIG. 3 illustrates a block diagram of interactions between an exercise controller and a training tactics database within the tactical training system according to the disclosed embodiments.

FIG. 4 illustrates a supervised learning pipeline for training and using a select tactics model according to the disclosed embodiments.

FIG. 5 illustrates a flowchart for real-time generation of training tactics according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The present disclosure is directed to a system that can coordinate the targeted aircraft's location with the shooter's aircraft location using historical weapon shot data and real-time simulations. The system also may choose a recommended and effective weapon to be fired and then real-time inform the pilot of successful weapon shot scenarios. This data would then be collected and provided for future missions and training simulations.

Implementation of the disclosed embodiments may increase the accuracy and precision of the pilot's shots to provide the pilot a better chance of a successful mission. The disclosed embodiments also allow for training pilots of successful tactical maneuvers that may be outside their area of expertise. Because the model used by the system is learning, these tactics may improve continuously with the pilots. The models also are paired with the skills of the pilots, thereby augmenting that tactics the model recommends based upon pilot skill level.

Less time between shots and successful targeting may reduce the rate of casualties and minimize loss. The disclosed system may alert the pilot or trainer as to the most effective weapon and maneuvers given historical data and scenarios. These features may result in more effective training and successful outcomes.

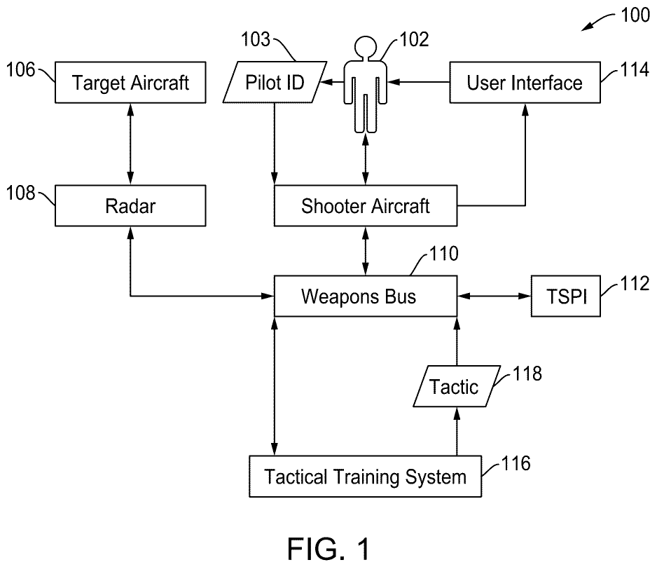

FIG. 1 depicts a block diagram of a live, virtual, and constructive (LVC) system 100 for training a pilot 102 according to the disclosed embodiments. Although pilot is used for the person being trained by system 100, any designation may be provided for this person, such as trainee, combat trainee, and the like. Pilot 102 is provided information using LVC system 100 and makes decisions using this information. LVC system 100 may provide a live simulation with real people operating real systems. These actions may be considered simulations as they may not be conducted against a live enemy.

LVC system 100 also is virtual as it uses simulation involving real people, such as pilot 102, operating simulated systems. The virtual simulations provided by LVC 100 may place pilot 102 in a central role by exercising motor skills for flying an aircraft and engages an adversary. These engagements may include firing of weapons at the adversary. LVC system 100 allow pilot 102 to train in these conditions without the need of actually using an aircraft. Pilot 102 makes inputs during simulations but may not be involved in determining outcomes. A constructive simulation provided by LVC system 100 may determine the speed of movement, the effect of firing or activating a weapon, and any result that may occur.

LVC system 100 may provide live, virtual, and constructive tactical training for engagements between shooter aircraft 104 operated by pilot 102 and target aircraft 106. Radar 108 may detect target aircraft 106 and alert pilot 102. In some embodiments, pilot 102 is flying a pre-defined mission, such as a sortie with defined flight path and events. Weapons bus 110 receives input data from radar 108. This input data may include target aircraft 106 and environmental data. Weapons bus 110 also receives input data from shooter aircraft 104 and time-space position information (TSPI) device 112. TSPI information may include global positioning system (GPS) information along with inertia information.

LVC system 100 also includes LVC tactical training system 116 that receives and provides data to weapons bus 110. LVC tactical training system 116 may be an advanced tactical training system with artificial intelligence (AI) or machine learning (ML) capabilities. Weapons bus 110 provides the radar data (target aircraft 106 or environmental information), shooter TSPI data, the pilot identification 103, weapons events, and the like to training system 116. Training system 116 selects the best tactic for pilot 102 to use within shooter aircraft 104 based on the received information and the functionality disclosed below.

Training system 116 pushes selected tactic 118 to weapons bus 110 of system 100. Weapons bus 110 passes tactic 118 to shooter aircraft 104. Shooter aircraft 104 sends selected tactic 118 to LVC training user interface 114 to prompt pilot 102. Pilot 102 then may execute selected tactic 118 to engage target aircraft 106. Alternatively, pilot 102 may disregard selected tactic 118. System 100 also may capture the result of executing selected tactic 118. These results, including whether pilot 102 disregarded selected tactic 118, flows back through shooter aircraft 104 to weapons bus 110. Weapons bus 110 provides the results to training system 116.

User interface 114 may be the primary device for interacting with pilot 102. User interface 114 may be a helmet worn by pilot 102 while using system 100. User interface 114 also may be a heads up display (HUD). In some embodiments, user interface may include audio transmitters and receivers to provide audio instructions and capture sound provided by pilot 102. In other embodiments, user interface 102 may be a console or tablet to interact with pilot 102.

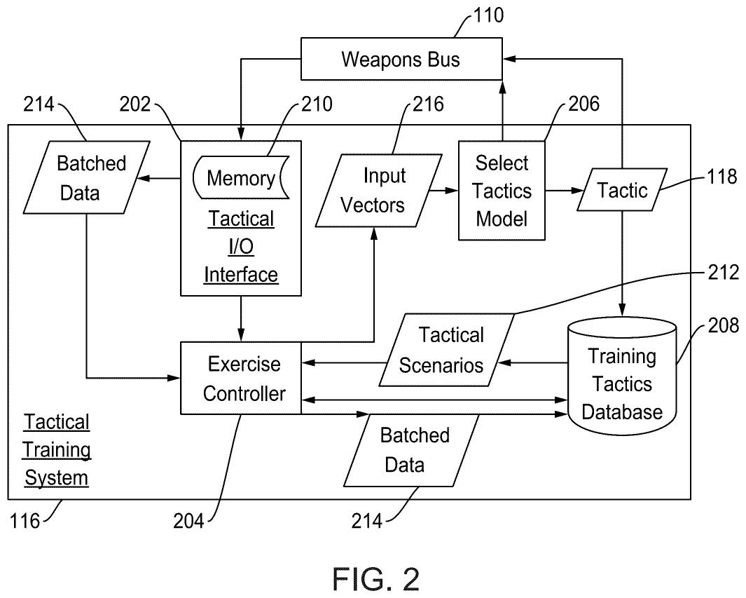

FIG. 2 depicts a block diagram of LVC tactical training system 116 according to the disclosed embodiments. Training system 116 interacts with weapons bus 110 of system 100 to receive data and information and provide selected tactic 118 to be presented to pilot 102. Training system 116 includes tactical input/output (I/O) interface 202, exercise controller 204, select tactics model 206, and training tactics database 208.

Tactical I/O interface 202 receives the data and information from weapons bus 110. This information, as disclosed above, includes radar data, shooterTSPI data, pilot identification 103, weapons events, and the like. Tactical I/O interface 202 batches and refines the received data. As may be appreciated, a large amount of data is coming into training system 116. Tactical I/O interface 202 may refine this large amount of data to be watershed moments to help train.

In some embodiments, tactical I/O interface 202 records data of a certain type and at certain instances, such as when radar 108 locks onto target aircraft 106. Tactical I/O interface 202 may capture the data as it flows into training system 116. The data may be buffered in memory 210. These actions reduce the amount of data and information flowing into training system 116. Tactical I/O interface 202 may implement rules defined for training system 116 on when to detect and record data from weapons bus 110. Alternatively, tactical I/O interface 202 may be trained to identify and determine when to record or capture data from weapons bus 110.

Tactical I/O interface 202 may batch the captured data by event as defined by system 100. For example, the event may be detecting and locking onto target aircraft 106. Weapons bus 110 may pass along that the event is a locked on target so that tactical I/O interface 202 starts capturing data and information being fed to training system 116 by weapons bus 110. Tactical I/O interface 202 then provides batched data 214 to exercise controller 204.

Exercise controller 204 receives batched data 214. Exercise controller 204 may perform additional processing than provides batched data 214 to LVC training tactics database 208. Training tactics database 208 populates entries or fields within the database with the data. Training tactics database 208 generates multiple tactical scenarios 212 and passes them to exercise controller 204.

Exercise controller 204 runs different simulations and calculations to generate input vectors 216. Input vectors 216 are based on the information provided by training tactics database 208. Input vectors 216 are sent to select tactics model 206. Exercise controller 204 also sends input vectors 216 to training tactics model 208 for storage.

Select tactics model 206 uses input vectors 216 as input into a trained model or machine learning process to select the best tactic 118 for the current situation in play with pilot 102, shooter aircraft 104, and target aircraft 106. Select tactics model 206 also may be known as a select and push tactics routine for tactical training system 116. Selected tactic 118 is pushed to weapons bus 110 as well as to training tactics database 208 for storage. Selected tactic 118 may be associated with pilot identification 103 so that the tactic and result are stored.

Shooter aircraft 104 sends selected tactic 118 to user interface 114 to prompt pilot 102 to execute the tactic in dealing with target aircraft 106. Whether or not pilot 102 decides to disregard or accept selected tactic 118 is captured. This information will flow back through shooter aircraft 104 to weapons bus 110 to update training tactics database 208 with the decision of pilot 102 and the results of the performance of selected tactic 118. Results may include information and data on pilot skill failure, failed tactic, target aircraft out-performed the tactic, system error, success, and the like.

These features may be repeated throughout operation. Weapons bus 110 may continue to provide data to tactical I/O interface 202, which refines and batches the data to be used in generating selected tactic 118. The specific features with regards to the processes implemented within system 100 and tactical training system 116 may be disclosed in greater detail below. The results of the operations will update training tactics database 208, which provides updated tactical scenarios 212 to exercise controller 204. Exercise controller 204, in turn, generates updated input vectors 216 that are provided to select tactics model 206.

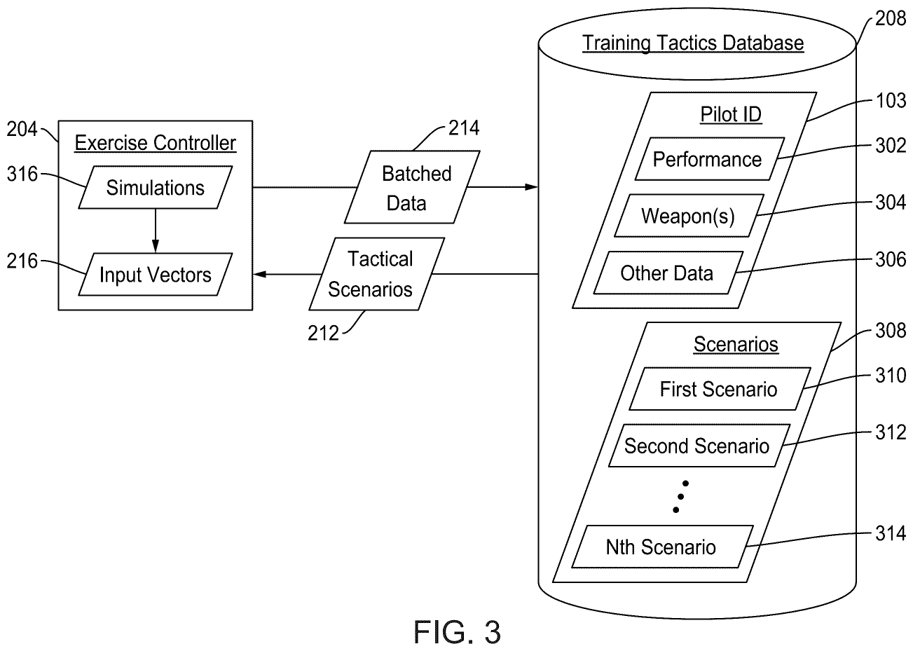

FIG. 3 depicts a block diagram of interactions between exercise controller 204 and training tactics database 208 within tactical training system 116 according to the disclosed embodiments. Exercise controller 204 receives batched data 214 from tactical I/O interface 202. Exercise controller 204 may be a processor that executes operations as disclosed herein. Batched data 214 is used to populate training tactics database 208.

Training tactics database 208 stores data for use by tactical training system 116. The database includes scenarios 308 that are provided for generating possible tactics to provide to weapons bus 110. Scenarios 308 provide different scenarios to recommend based on batched data 214. Training tactics database 208 may match one or more scenarios 308 to the data and information provided by batched data 214, as captured by tactical I/O interface 202. For example, if target shooter 106 is a specific type of aircraft operating under certain environmental conditions and other parameters such as distance, speed, and the like, then training tactics database 208 will identify one or more scenarios to be selected to send to weapons bus 110. Further, batched data 214 may include information about shooter aircraft 104.

Scenarios 308 may include first scenario 310, second scenario 312, up to Nth scenario 314. One or more of these scenarios may be provided as tactical scenarios 212 back to exercise controller 204. In selecting tactical scenarios 212, training tactical database 208 takes into account information stored therein pertaining to pilot 102. Pilot identification 103 is provided. An entry for pilot 102 including information regarding the pilot, past missions, weapons available to the pilot or shooter aircraft 104, plus other information may be found in training tactics database 208.

For example, an entry for pilot identification 103 within training tactics database 208 may include performance data 302. Performance data 302 may relate to previous tactics recommended to pilot 102 and whether they were accepted, disregarded, failed, successful, and the like.

Training tactics database 208 may include entries based on pilot identification 103. An entry may include pilot performance from previous interactions and results, weapons made available to pilot 102, preferences, and the like. Training tactics database 208 updates this information associated with pilot identification 103 after each operation that involves a tactic provided in response to a situation. Training tactics database 208 pulls the information associated with pilot identification 103 and uses it with batched data 214 to select one or more scenarios 308 to be provided as tactical scenarios 212.

For example, pilot identification 103 may indicate that pilot 102 is not an experienced pilot and has few flying hours within shooter aircraft 104. Further, pilot 102 has not been trained on the use of all the weapons available for use on shooter aircraft 104. Batched data 214 indicates that target aircraft 106 is a certain distance away from shooter aircraft 104 and that it is night time. Thus, training tactics database 208 determines that first scenario 310 meets the criteria for a suitable tactic to recommend based on these parameters. Second scenario 312, however, may not be suitable as it is a tactic suited for more experienced pilots. Nth scenario 314 also may not be applicable as it is associated with day time operations. Thus, training tactics database 208 may include first scenario 310 with tactical scenarios 212 but will not include second scenario 312 or Nth scenario 314.

In some embodiments, tactical scenarios 212 may be tables populated with the data pulled from entries within training tactics database 208, including data associated with pilot identification 103 such pilot performance. Information should include data that shows pilot 102 can perform these actions. In some embodiments, the tables may be structured query language (SQL) tables. The SQL tables may be database objects that contain all the data in a database for the recommended tactic.

Exercise controller 204 receives tactical scenarios 212 and performs different simulations and calculations to generate input vectors 216, via a combination of what if scenarios involving the pilot's historical success of performing airborne maneuvers, the available options for tactics given the in-flight dynamics, enemy aircraft, and ally aircraft involved in the engagement. Exercise controller 204 may be a processor that executes operations to generate input vectors from the tables provided in tactical scenarios. It may use the data entries to generate a vector for input into an AI model. Exercise controller 204 provides input vectors 216 to select tactics model 206 and back to training tactics database 208 for storage in order to support historical information of what tactics were recommended, and then later record success or failure, to help continuously refine training tactics database 208.

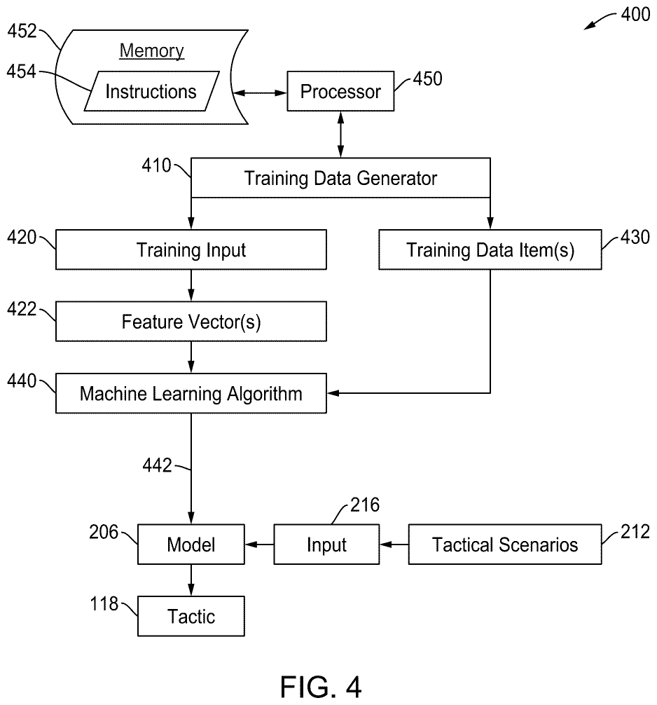

FIG. 4 depicts a supervised learning pipeline 400 for training and using select tactics model 206 according to the disclosed embodiments. Select tactics model 206 may be generated and trained using supervised learning pipeline 400. Select tactics model 206 then may be applied to determine a selected tactic 118 to provide to weapons bus 110.

Supervised learning pipeline 400 includes training data generator 410, training input 420, one or more feature vectors 422, one or more training data items 430, machining learning algorithm 440, actual input 1250, one or more tactical scenarios 212, select tactics model 205, and selected tactic 118. Part or all of supervised learning pipeline 400 may be implemented by executing software for part or all of supervised learning pipeline 400 using one or more processors or other components within tactical training system 116.

In some embodiments, one or more processors 450 may be used to implement supervised learning pipeline 400. Processor 450 may execute within tactical training system 116. Alternatively, processor 450 may be located apart from tactical training system 116 such that select tactics model 206 is provided to tactical training system 116. Processor 450 is communicatively coupled to memory 452, which stores instructions 454. Processor 450 executes instructions 454 to configure the processor into a special purpose computer that executes the processes disclosed herein.

In operation, supervised learning pipeline 400 may involve two phases: a training phase and a prediction phase. The training phase may involve machine learning algorithm 440 learning one or more tasks related to detecting attributes or strategies for use by the model. The prediction phase may include selected tactics model 206, which is a trained version of machine learning algorithm 440 and makes predictions to accomplish one or more tasks for determining selected tactic 118 to provide to weapons bus 110. In some embodiments, machine learning algorithm 440 or selected tactics model 206 may include one or more artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the training phase of supervised learning pipeline 400, training data generator 410 may generate training input 420 and training data item(s) 430. Training input 420 may be processes to determine one or more feature vectors 422. In some embodiments, training input 420 may be preprocessed. For example, for each scenario within training tactics database 208, training input 420 may be preprocessed to the output or information received from the applicable entry or scenario. The tables, factors, scores, attributes, strategies, results, and the like may be used as part of training input 420. In some embodiments, training data generator 410 is not used to generate training input 420 or training data items(s).

Feature vector(s) 422 may be provided to machine learning algorithm 440 to learn one or more tactic applicable to a given scenario along with identified information and pilot information. After performing the one or more tasks, machine learning algorithm 440 may generate one or more outputs 442 based on feature vector(s) 422 and, optionally, training data items 430.

During training, training data items 430 may be used to make an assessment of the outputs 442 of machine learning algorithm 440 for accuracy. Machine learning algorithm 440 may be updated based on this assessment. Training of machine learning algorithm 440 is considered to be trained to perform the one or more tasks for providing a probability for tactic to be used based on a scenario. Once trained, machine learning algorithm 440 may be considered to be select tactics model 206. In other words, select tactics model 206 may be generated from the training of machine learning algorithm 440. In some embodiments, machine learning algorithm 440 also is known as a model.

During the prediction phase of supervised learning pipeline 400, tactical scenarios 212 from training tactics database 208 may be used by exercise controller 204 to generate one or more input vectors 216. In some embodiments, some or all of input vectors 216 include one or more forms of data disclosed above. Tactical scenarios 212 may be provided to selected tactics model 206 via input vectors 216. Selected tactics model 206 may generate an output, such as selected tactic 118, based on tactical scenarios 212 selected by training tactics database 208 based on batched data 214 and pilot identification 103, along with applicable pilot-related information. The outputs of select tactics model 206 may be provided as selected tactic 118. Selected tactic 118 is provided to weapons bus 110 to be propagated through shooter aircraft 104 to pilot 102.

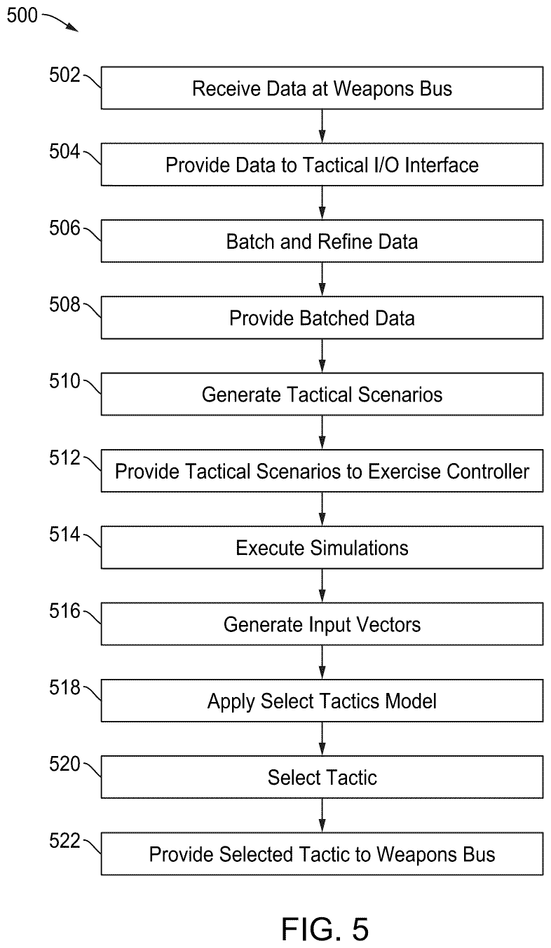

FIG. 5 depicts a flowchart 500 for real-time generation of training tactics according to the disclosed embodiments. Flowchart 500 may refer to FIGS. 1-4 for illustrative purposes. Flowchart 500, however, is not limited to the embodiments disclosed by FIGS. 1-4.

Step 502 executes by receiving input data at weapons bus 110 from various components of shooter aircraft 104. Pilot 102 may be flying a pre-defined mission, such as a sortie with a defined flight path and events. Radar 108 may detect target aircraft 106. Shooter aircraft 104 captures data from radar 108, TSPI device 112, and other components. Further, pilot identification 103 is provided.

Step 504 executes by providing the input data to tactical I/O interface 202 of tactical training system 116 from weapons bus 110. Step 506 executes by batching and refining the input data within tactical I/O interface 202. For example, tactical I/O interface 202 may capture data based on an event occurring as opposed to continuously capturing data. This feature reduces the processing load on tactical training system 116.

Step 508 executes by providing batched data 214 from tactical I/O interface 202 to exercise controller 204. Exercise controller 204 then provides batched data 214 to training tactics database 208. Training tactics database 208 may use batched data 214 to populate entries for querying the database. Step 510 executes by generating tactical scenarios 212 from entries within training tactics database 208 based on batched data 212 as well information corresponding to pilot identification 103. Step 512 executes by providing tactical scenarios 212 to exercise controller 204 from training tactics database 208.

Step 514 executes by executing simulations 316 at exercise controller 204 on tactical scenarios 212. Exercise controller 204 also may perform calculations using the information within the tables for tactical scenarios 212. Step 516 executes by generating input vectors 216 based on executed simulations 316. Input vectors 216 should include information appropriate for input into a model or machine learning process. In some embodiments, an input vector 216 is generated for each tactical scenario 212 provided by training tactical database 208.

Step 518 executes by applying select tactics model 206 to input vectors 216. Select tactics model 206 may apply select routines to each input vector, which, in turn, takes into consideration the tactical scenarios provided by the database. Using a trained model, the disclosed embodiments may process each input vector to determine one or more that best fit the current situation faced by pilot 102.

Step 520 executes by selecting tactic 118 using select tactics model 206. In some embodiments, select tactics model 206 predicts the most accurate tactic that applies to the current situation as determined from the selected scenarios faced by the pilot. Step 522 executes by providing selected tactic 118 to weapons bus 110 of system 100. Weapons bus 110 then propagates selected tactic 118 through system 100 to pilot 102 using user interface 114.

Flowchart 500 may execute recursively throughout operation of system 100. Further, results generated by pilot 102 in responding to tactic 118 is captured and fed back to training tactics database 208 through tactical training system 116. Database 208 may update the information associated with pilot identification 103 with the results so that the results are taken into account during the next iteration.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A system for generating live, virtual, and constructive training tactics, the system comprising:
a tactical input/output (I/O) interface configured to receive input data and batch the input data in response to an event;
a training tactics database configured to generate at least one tactical scenario from scenarios stored within the training tactics database, wherein the at least one tactical scenario is generated based on the batched input data and data related to a user identification stored within the training tactics database;
an exercise controller configured to execute simulations for each tactical scenario of the at least one tactical scenario to generate at least one input vector; and
a select tactics model configured to receive the at least one input vector to determine a selected tactic in response to the event.

2. The system of claim 1, wherein the exercise controller receives the batched input data and provides the batched input data to the trainings tactics database.

3. The system of claim 1, wherein the input data includes at least one of environmental data, target aircraft data, time-space position information data, and weapons data.

4. The system of claim 1, wherein the tactical I/O interface is configured to capture the input data when the event is detected.

5. The system of claim 1, wherein the exercise controller is configured to provide the at least one input vector to the training tactics database.

6. The system of claim 1, wherein the select tactics model is configured to provide the selected tactic to the training tactics database.

7. The system of claim 6, wherein the training tactics database associates the selected tactic to the user identification.

8. The system of claim 1, wherein the user identification includes a pilot identification such that the data related to the pilot identification includes pilot performance data.

9. A live, virtual, and constructive (LVC) training system for an aircraft, the LVC training system comprising:
a weapons bus to receive input data from components related to the aircraft;
a user interface to provide a selected tactic to a user of the aircraft; and
a tactical training system to generate the selected tactic used by the user interface, wherein the tactical training system includes
a tactical input/output (I/O) interface configured to receive the input data and batch the input data in response to an event related to the aircraft,
a training tactics database configured to generate at least one tactical scenario from scenarios stored within the training tactics database, wherein the at least one tactical scenario is generated based on the batched input data and data related to a user identification of the user stored within the training tactics database,
an exercise controller configured to execute simulations for each tactical scenario of the at least one tactical scenario to generate at least one input vector, and
a select tactics model configured to receive the at least one input vector to determine the selected tactic in response to the event.

10. The LVC training system of claim 9, wherein the select tactics model provides the selected tactic to the weapons bus.

11. The LVC training system of claim 10, wherein the weapons bus provides the selected tactic to the user interface through the aircraft.

12. The LVC training system of claim 9, further comprising a radar to provide target aircraft data within the input data to the weapons bus.

13. The LVC training system of claim 12, wherein the radar provides environmental data within the input data to the weapons bus.

14. The LVC training system of claim 9, further comprising a time-space position information (TSPI) device to provide positioning information data within the input data to the weapons bus.

15. The LVC training system of claim 9, wherein the user identification includes a pilot identification such that the data related to the pilot identification includes pilot performance data.

16. A method for generating real-time tactics for a live, virtual, and constructive (LVC) training system, the method comprising:
receiving input data at a tactical input/output (I/O) interface of a tactical training system of the LVC system;
batching the input data in response to an event within the LVC system;
generating at least one tactical scenario from scenarios stored at a training tactics database based on the batched data and data related to a user identification stored within the training tactics database;
executing simulations at an exercise controller for each tactical scenario of the at least one tactical scenario;
generating at least one input vector for the at least one tactical scenario by the exercise controller based on the simulations; and
determining a tactic for the LVC system based on the at least one input vector using a select tactics model.

17. The method of claim 16, further comprising
receiving the batched data from the tactical I/O interface at the exercise controller, and
providing the batched data from the exercise controller to the training tactics database.

18. The method of claim 16, further comprising providing the at least one input vector to the training tactics database.

19. The method of claim 16, wherein receiving the input data includes receiving the input data from a weapons bus of the LVC system.

20. The method of claim 16, further comprising associating the tactic to the user identification.
